(19) United States
(12) Patent Application Publication
(10) Pub. No.: US 2025/0286743 A1
(43) Pub. Date: Sep. 11, 2025

(54) PROCESSING SYSTEM AND PROCESSING METHOD

(71) Applicant: FUJIFILM Business Innovation Corp., Tokyo (JP)

(72) Inventors: Tomoki TANIHATA, Kanagawa (JP); Masahiko Otsu, Kanagawa (JP); Kenta Nomura, Kanagawa (JP); Toma Taguchi, Kanagawa (JP)

(73) Assignee: FUJIFILM Business Innovation Corp., Tokyo (JP)

(21) Appl. No.: 18/779,828

(22) Filed: Jul. 22, 2024

(30) Foreign Application Priority Data
Mar. 6, 2024 (JP) 2024-034364

(51) Int. Cl. H04L 12/10; H04L 12/12

(52) U.S. Cl. CPC H04L 12/10; H04L 12/12

(57) ABSTRACT

A processing system includes: a first storage unit configured to store part of a plurality of processing procedures for processing a packet received via a network; a second storage unit configured to store information on the processing procedures and attribute information related to a power reduction effect in association with each other; and a first processor configured to execute, when a new processing procedure is not able to be added to the first storage unit due to a capacity shortage of the first storage unit, update processing of deleting one of the processing procedures the power reduction effect provided by which is lowest based on the attribute information and then adding the new processing procedure to the first storage unit.

### CROSS-REFERENCE TO RELATED APPLICATIONS

This application is based on and claims priority under 35 USC 119 from Japanese Patent Application No. 2024-034364 filed Mar. 6, 2024.

### BACKGROUND

### (i) Technical Field

The present disclosure relates to a processing system and a processing method.

### (ii) Related Art

Japanese Unexamined Patent Application Publication No. 2020-205532 discloses the following information processing apparatus. Specifically, the information processing apparatus includes: a power supply control unit that switches between a first power supply mode and a second power supply mode; a main control unit that executes, under the first power supply mode, predetermined processing in accordance with a received packet acquired via a network; and a communication unit that executes processing of transferring the received packet to the main control unit under the first power supply mode and executes processing of discarding the received packet or transferring the received packet to the main control unit under the second power supply mode. The communication unit includes a setting management unit that manages a discard determination pattern which is information for determining whether to discard the received packet or to transfer the received packet to the main control unit. The main control unit includes a setting change unit that changes a list of the discard determination patterns managed by the setting management unit, based on determination on whether processing on the received packet in the main controller is discard processing.

### SUMMARY

Aspects of non-limiting embodiments of the present disclosure relate to a processing system and a processing method enabling a processing procedure with a high power reduction effect to be retained when a new processing procedure is added to a first storage unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a processing system including: a first storage unit configured to store part of a plurality of processing procedures for processing a packet received via a network; a second storage unit configured to store information on the processing procedures and attribute information related to a power reduction effect in association with each other; and a first processor configured to execute, when a new processing procedure is not able to be added to the first storage unit due to a capacity shortage of the first storage unit, update processing of deleting one of the processing procedures the power reduction effect provided by which is lowest based on the attribute information and then adding the new processing procedure to the first storage unit.

### BRIEF DESCRIPTION OF THE DRAWINGS

Exemplary embodiments of the present disclosure will be described in detail based on the following figures, wherein:

FIG. 1 is a block diagram illustrating a hardware configuration of an information processing system according to a first exemplary embodiment;

FIG. 2 is a block diagram illustrating an example of a functional configuration of a main processing unit in the information processing system;

FIG. 3 is a block diagram illustrating an example of a functional configuration of a communication unit in the information processing system;

FIG. 4 is a diagram illustrating an example of a proxy response pattern;

FIG. 5(A) is a diagram illustrating an example of a setting screen for setting attribute information displayed on an operation panel, and FIG. 5(B) is a diagram illustrating an example of a setting report in which the attribute information is set;

FIG. 6 is a flowchart illustrating a flow of update determination processing executed by the main processing unit of the information processing system according to the first exemplary embodiment;

FIG. 7 is a flowchart illustrating a flow of processing for measuring a packet processing time executed by the main processing unit of the information processing system according to the first exemplary embodiment; and

FIG. 8 is a flowchart illustrating a flow of processing executed by the communication unit of the information processing system according to the first exemplary embodiment to accumulate usage records.

### DETAILED DESCRIPTION

Hereinafter, an example of an exemplary embodiment according to the present disclosure will be described with reference to the drawings. Note that in the drawings, the same or equivalent components and parts are denoted by the same reference signs. In addition, dimensional ratios in the drawings are exaggerated for convenience of description and may be different from actual ratios.

### First Exemplary Embodiment

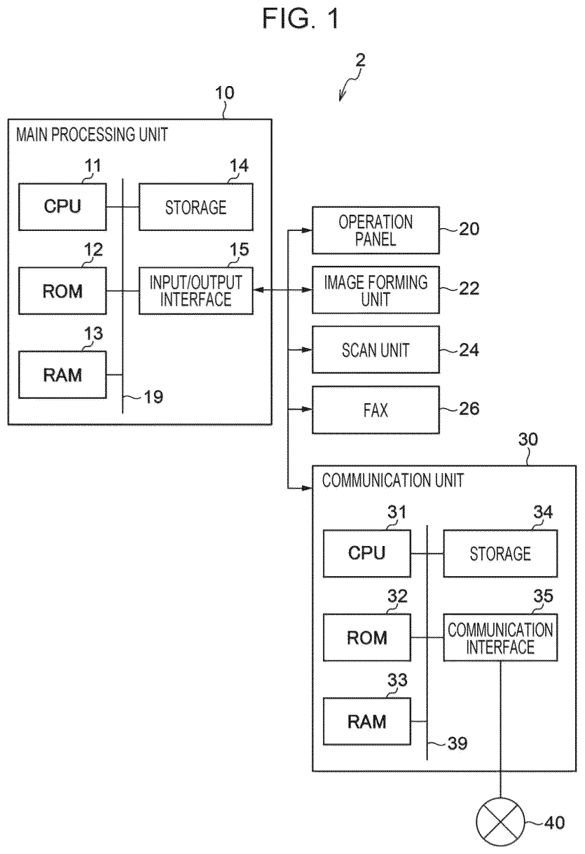

FIG. 1 is a block diagram illustrating a hardware configuration of an information processing system 2 as an example of a processing system according to a first exemplary embodiment.

### Hardware Configuration of Information Processing System

For example, the information processing system 2 includes a main processing unit 10, an operation panel 20, an image forming unit 22, a scan unit 24, a fax machine 26, and a communication unit 30. Thus, the information processing system 2 includes the image forming unit 22, the scan unit 24, the fax machine 26, and the communication unit 30, to be configured as a multifunction peripheral having functions of those of a printer, a copier, and a facsimile, as well as e-mail transmission and the like. Alternatively, the information processing system 2 may be applied to a computer apparatus such as a desktop computer, a laptop computer, or a tablet computer having a mail transmission function. The “system” in the present disclosure includes both a system configured by a plurality of apparatuses and a system configured by a single apparatus.

As illustrated in FIG. 1, the main processing unit 10 includes the following components: a central processing unit (CPU) 11, a read only memory (ROM) 12, a random access memory (RAM) 13, a storage 14, and an input/output interface 15. The components are communicably connected to each other via a bus 19.

The CPU 11 is a central processing unit, and executes various programs and controls each unit. The CPU 11 is an example of a first processor. The CPU 11 reads a program from the ROM 12 or the storage 14, and executes the program using the RAM 13 as a work area. In the present exemplary embodiment, a processing program is stored in the ROM 12 or the storage 14. The CPU 11 controls the above-described components and performs various kinds of arithmetic processing in accordance with the processing program stored in the ROM 12 or the storage 14.

The ROM 12 stores therein various programs and various types of data. The RAM 13, serving as a work area, temporarily stores therein programs or data. The storage 14 includes a hard disk drive (HDD) or a solid state drive (SSD), and stores various programs including an operating system and various types of data.

The input/output interface 15 is an interface for transmitting and receiving information to and from peripheral devices of the main processing unit 10. The input/output interface 15 is connected to each of the operation panel 20, the image forming unit 22, the scan unit 24, the fax machine 26, and the communication unit 30, and can transmit and receive information to and from each of these components. Note that in the information processing system 2 according to the present disclosure, instead of this configuration, the input/output interface 15 may be directly connected to at least one of the operation panel 20, the image forming unit 22, the scan unit 24, the fax machine 26, and the communication unit 30 via the bus 19.

The operation panel 20 has a function of a display unit which displays various types of information and a function of an input unit which is operated by a user. As an example, the operation panel 20 is a touch panel user interface (UI), and is a touch panel display having a touch panel superimposed on a liquid crystal display.

The image forming unit 22 acquires image data and forms an image on a recording medium. The image forming unit 22 executes, for example, processing for conveying a recording medium to an image forming position, processing for forming an image on the recording medium, processing for ejecting the discharging the recording medium on which the image has been formed, and the like. Specifically, the image forming unit 22 includes an electrophotographic image forming mechanism, a recording medium conveying mechanism, and the like, and upon receiving image data indicating an image to be printed and various operation commands from the main processing unit 10, performs printing on one side or both sides of the recording medium and then discharges the recording medium to an external paper output tray.

The scan unit 24 conveys a plurality of documents and reads each of the documents. Specifically, the scan unit 24 executes processing for conveying a document to a reading position, processing for reading the document, processing for discharging the document, and the like. When an operation command for reading a document is input from the main processing unit 10, the scan unit 24 reads the document, acquires image data which is the read image, and discharges the document to a discharge portion.

The fax machine 26 performs management for a destination to which image data or the like is transmitted, transmission and reception of the image data, and the like. For example, the fax machine 26 executes processing for transmitting image data read by the scan unit 24 to a designated destination or receiving image data transmitted from the outside. The fax machine 26 has, for example, a communication function for transmitting and receiving image data and the like. Note that alternatively, the fax machine 26 may transmit and receive image data and the like via the communication unit 30.

The communication unit 30 has an information communication function. The communication unit 30 includes components including a central processing unit (CPU) 31, a read only memory (ROM) 32, a random access memory (RAM) 33, a storage 34, and a communication interface 35. The components are communicably connected to each other via a bus 39. The communication unit 30 performs packet communications, for example, over a network 40 described later. A packet refers to a unit of transmission in a case where data is divided into small pieces data of a specific size to be sent in information communication, and refers to a mass of data exchanged over a network. For example, when communication is performed for large amount of data, the data is divided. Then, each of the divided pieces of data is provided with control information such as an address and is communicated.

The CPU 31 is a central processing unit of the communication unit 30, and executes various programs and controls the components in the communication unit 30. The CPU 31 is an example of a second processor.

The ROM 32 stores therein various programs and various types of data. The RAM 33 serves as a work area and temporarily stores therein programs or data. The storage 34 is configured by an HDD or an SSD and stores various programs and various types of data.

The communication interface 35 is an interface for communicating with the network 40, using for example, a standard such as Ethernet (registered trademark), FDDI, or Wi-Fi (registered trademark). The network 40 is, for example, the Internet, or a wired or wireless network. As an example, the information processing system 2 is connected to a server (not illustrated) via the network 40, and can perform information communication with the server.

### Functional Configuration of Main Processing Unit

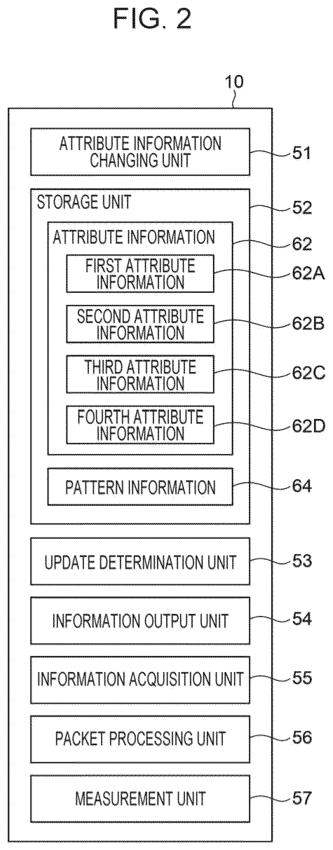

FIG. 2 is a block diagram illustrating an example of a functional configuration of the main processing unit 10 in the information processing system 2.

As illustrated in FIG. 2, the main processing unit 10 includes, as functional configurations, an attribute information changing unit 51, a storage unit 52, an update determination unit 53, an information output unit 54, an information acquisition unit 55, a packet processing unit 56, and a measurement unit 57. Each of the functional configurations is realized by the CPU 11 reading an information processing program stored in the ROM 12 or the storage 14 and loading and executing the information processing program on the RAM 13.

The attribute information changing unit 51 changes attribute information 62, which is information on the attribute of a pattern. For example, the attribute information changing unit 51 changes the attribute information 62 based on the information acquired from the communication unit 30.

The storage unit 52 stores the attribute information 62 and pattern information 64 which is information on a plurality of patterns. The storage unit 52 is an example of a second storage unit. Furthermore, the plurality of patterns are an example of a plurality of processing procedures for processing packets received via the network 40. That is, a pattern is an example of a processing procedure. The pattern information 64 is information for identifying a plurality of patterns and is not the patterns themselves. The pattern information 64 includes, for example, ID information of the pattern and the like. The ID information is a code distinctively assigned by an information device or service provider to each of the patterns.

In the first exemplary embodiment, the RAM 13 of the main processing unit 10 or the storage 14 functions as the storage unit 52. The storage unit 52 preferably has a relatively long service life and a relatively large storage capacity. The storage unit 52 includes, for example, a nonvolatile semiconductor memory (flash memory) stored contents in which are retained even when the power is turned OFF.

As described above, the attribute information 62 is information on the attribute of the pattern. The attribute information 62 includes information on a power reduction effect of a pattern. The attribute information 62 includes, for example, first attribute information 62A, second attribute information 62B, third attribute information 62C, and fourth attribute information 62D. The attribute information 62 is not limited to the first attribute information 62A, the second attribute information 62B, the third attribute information 62C, and the fourth attribute information 62D, and may include other types of attribute information.

The first attribute information 62A is, for example, rewritability information of a pattern indicating whether the pattern is rewritable. The pattern rewritability information can be set by, for example, a user or a developer of the pattern.

The second attribute information 62B is, for example, the usage record count of the pattern. For example, when the pattern is used on the communication unit 30 side in an energy-saving state as will be described later, the information on the usage record count is temporarily stored in the RAM 33 on the communication unit 30 side, and the information on the usage record count is read from the communication unit 30 at the time of return from the energy-saving state to be stored in the storage unit 52.

The third attribute information 62C is, for example, the packet processing time. For example, when the packet processing unit 56 processes a packet, the measurement unit 57 measures the processing time of the packet and stores the measured processing time of the packet as the third attribute information 62C. Note that the packet processing time may have an initial value set in advance.

The fourth attribute information 62D is, for example, expected power reduction effect information. The expected power reduction effect information is calculated as the product of the usage record count of the pattern, which is the second attribute information 62B, and the packet processing time, which is the third attribute information 62C.

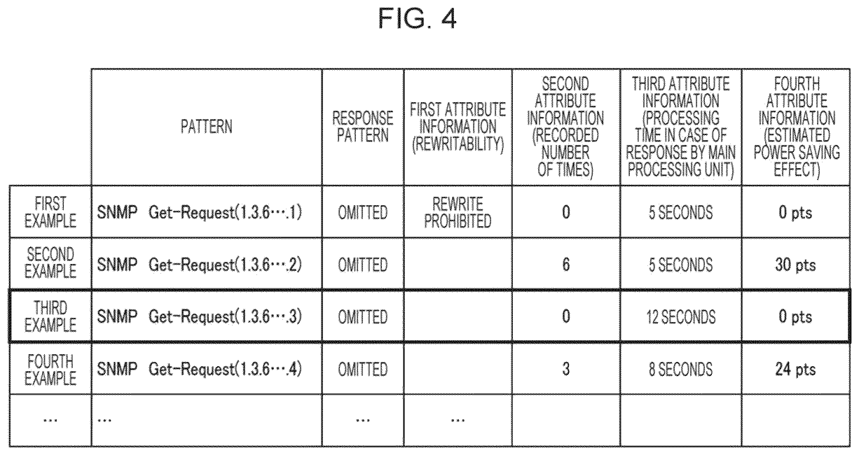

FIG. 4 illustrates an example of a table in which a proxy response pattern and the attribute information 62 are associated with each other. For example, the table illustrated in FIG. 4 is stored in the storage unit 52. As illustrated in FIG. 4, the pattern of the third example is not unrewritable (that is, rewritable), and the power reduction effect, which is a numerical value of the fourth attribute information 62D, provided therewith is the lowest.

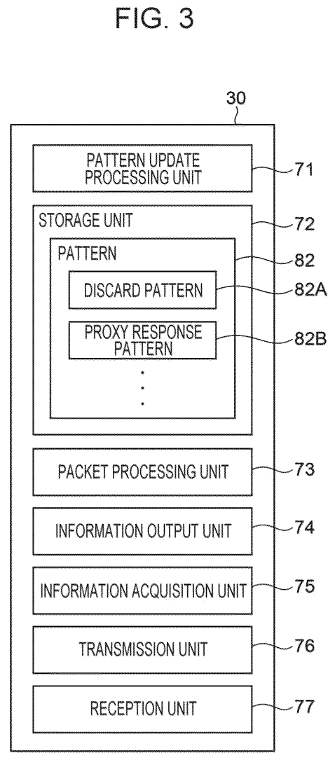

The update determination unit 53 determines whether to cause the communication unit 30 to perform update processing for a new pattern. For example, the update determination unit 53 determines that the new pattern can be stored in the storage unit 72 when a storage unit 72 (see FIG. 3) of the communication unit 30 has a sufficient capacity, or that the new pattern cannot be stored in the storage unit 72 when the storage unit 72 (see FIG. 3) of the communication unit 30 does not have a sufficient capacity. When the new pattern cannot be added to the storage unit 72 due to a capacity shortage of the storage unit 72 of the communication unit 30, for example, the main processing unit 10 (for example, the CPU 11) causes the communication unit 30 to execute update processing of deleting a pattern with the lowest power reduction effect based on the attribute information 62 and then adding the new pattern to the storage unit 72.

The update determination unit 53 selects the deletion target pattern with the lowest power reduction effect based on the attribute information 62 (for example, the usage record count of the pattern which is the second attribute information 62B and the pattern processing time which is the third attribute information 62C). For example, as illustrated in FIG. 4, the pattern of the third example is not unrewritable (that is, rewritable), and the power reduction effect, and the power reduction effect, which is a numerical value of the fourth attribute information 62D, provided therewith is the lowest. Therefore, the pattern of the third example is selected as the deletion target at the time of the next update.

When the pattern rewritability information which is the first attribute information 62A indicates that the pattern is unrewritable, the update determination unit 53 does not cause the communication unit 30 to delete the pattern in the storage unit 72 regardless of the power reduction effect. For example, as illustrated in FIG. 4, the first attribute information 62A indicates that a pattern of a first example is unrewritable. In this case, the pattern of the first example is not deleted.

For example, the update determination unit 53 acquires a pattern rewrite count, and does not cause the communication unit 30 to execute the update processing of adding the new pattern to the storage unit 72 when the pattern rewrite count is equal to or more than the specified value. Here, the pattern rewrite count indicates the number of times update processing such as deletion of a pattern or addition of a new pattern has been executed. For example, when a pattern is deleted and a new pattern is added, the rewrite count is two. The pattern rewrite count is acquired from the communication unit 30.

The information output unit 54 outputs information to the communication unit 30. For example, the information output unit 54 outputs, to the communication unit 30, a request to perform the update processing for a new pattern, a request to delete a deletion target pattern, and the like.

The information acquisition unit 55 acquires information from the communication unit 30. For example, information such as the pattern rewrite count is acquired from the communication unit 30.

The packet processing unit 56 processes a packet. In one example, when the packet is not processed by a discard pattern 82A or a proxy response pattern 82B (refer to FIG. 3) in the communication unit 30, the packet is processed by the packet processing unit 56 in the main processing unit 10.

The measurement unit 57 measures a packet processing time. The measurement unit 57 includes a timer and measures the packet processing time using the timer. For example, when a packet is the processing time measurement target, the measurement unit 57 measures the processing time for the packet. The packet processing time is stored in the storage unit 52 as the third attribute information 62C. The packet as the processing time measurement target is a packet involving no job. Examples of the job include printing on a recording medium by the image forming unit 22 and reading of a document by the scan unit 24. In other words, the packet involving no job is a packet for which only packet processing is executed and no job is performed. Since the packet involving no job is a target of filtering or an automatic response in the communication unit 30, the processing time of such a packet is accumulated in the third attribute information 62C.

### Setting Screen and Setting Report for Attribute Information

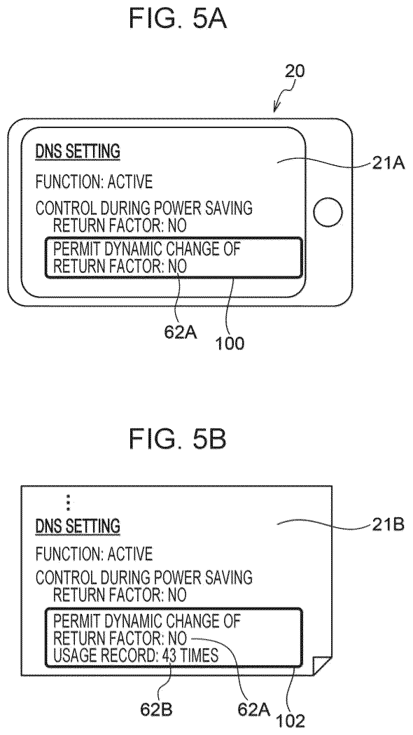

FIG. 5(A) illustrates an example of a setting screen for the user to set the attribute information, and FIG. 5(B) illustrates an example of a setting report for the user to check the attribute information 62. As illustrated in FIG. 5(A), a setting screen 21A for setting the attribute information 62 is displayed on the operation panel 20. On the setting screen 21A, “permit dynamic change of return factor” is set to “no” (thus, rewriting is prohibited). A black frame portion 100 in the setting screen 21A is a new portion. Thus, as the first attribute information 62A set by the user, the pattern can be set to be unrewritable. Note that unlike in the above-described setting screen 21A, the unrewritable part may be grayed out.

Further, as shown in FIG. 5(B), a setting report 21B for checking the setting of the attribute information is output to the recording medium by the image forming unit 22. Alternatively, the setting report 21B may be displayed on the operation panel 20. A black frame portion 102 in the setting report 21B is a new portion. In the setting report 21B, “permit dynamic change of return factor” is set to “no” (thus, rewriting is prohibited). Thus, it is confirmed that for the pattern, unrewritable is set as the first attribute information 62A. Further, in the setting report 21B, as the second attribute information 62B, it is confirmed that the usage record count of the pattern is 43 times.

### Functional Configuration of Communication Unit

FIG. 3 is a block diagram illustrating an example of a functional configuration of the communication unit 30 in the information processing system 2.

As illustrated in FIG. 3, the communication unit 30 includes, as functional configurations, a pattern update processing unit 71, a storage unit 72, a packet processing unit 73, an information output unit 74, an information acquisition unit 75, a transmission unit 76, and a reception unit 77. Each of the functional configurations is realized by the CPU 31 reading an information processing program stored in the ROM 32 or the storage 34 and loading and executing the information processing program on the RAM 33.

The pattern update processing unit 71 executes pattern update processing. The pattern update processing includes processing of deleting a pattern, adding a new pattern, and the like. For example, the pattern update processing unit 71 executes the pattern update processing upon acquiring a request to execute the pattern update processing from the main processing unit 10. The pattern on which the update processing has been executed is stored in the storage unit 72.

The storage unit 72 stores a plurality of patterns 82. The storage unit 72 is an example of a first storage unit. The plurality of patterns 82 are an example of a plurality of processing procedures for processing packets received via the network 40. Examples of the pattern 82 include the discard pattern 82A, the proxy response pattern 82B, and the like. The discard pattern 82A is, for example, a processing procedure for discarding a packet at the communication unit 30 without activating the main processing unit 10. The proxy response pattern 82B is, for example, a processing procedure for causing the communication unit 30 to perform a proxy response for a packet without activating the main processing unit 10.

In the first exemplary embodiment, the RAM 33 of the communication unit 30 or the storage 34 functions as the storage unit 72. The storage unit 72 includes, for example, a nonvolatile semiconductor memory (flash memory) stored contents in which are maintained even when the power is turned OFF. The rewrite count information for the pattern 82 may be stored in the storage unit 72 or may be stored in a memory other than the storage unit 72.

The service life of the storage unit 72 regarding the rewrite count is, for example, 100,000 times in the case of a flash ROM. A flash ROM (flash memory) is a type of electronically erasable and programmable read only memory (EEPROM), and is a ROM in which contents can be electrically erased and written in block units. In the storage unit 72, a specified value of the rewrite count of the pattern 82 is set in advance, and when the rewrite count of the pattern 82 in the storage unit 72 is equal to or more than the specified value, the main processing unit 10 (for example, the CPU 11) performs control to prohibit the rewrite of the pattern 82. The specified value is a value obtained by subtracting a margin from the service life of the storage unit 72 regarding the rewrite count (for example, 100,000 times in the case of a flash ROM), and for example, when the margin is 20%, the specified value is 80,000 times, which is 80% for example. As the storage unit 72, it is preferable to use a magnetoresistive random access memory (MRAM) or a ferroelectric random access memory (FRAM) (registered trademark) featuring a longer service life than a flash ROM. The MRAM uses a magnetic material as a part of the material of a storage element, and records a signal through a change in a magnetized state. The FRAM is a nonvolatile memory device using a dielectric substance as a storage element.

The packet processing unit 73 processes a packet. As an example, in a case where the packet received by the communication unit 30 corresponds to the discard pattern 82A in which the discarding is performed or corresponds to the proxy response pattern 82B in which the proxy response is performed, the packet processing unit 73 processes the packet without activating (booting) the main processing unit 10.

After processing the packet, the packet processing unit 73 stores, in the storage unit 72, incremental information for incrementing the pattern usage record count in the attribute information 62, without activating the main processing unit 10. For example, the incremental information may be temporarily stored in the storage unit 72, and thereafter, when the main processing unit 10 is activated, the main processing unit 10 may be notified of the incremental information. Upon being notified of the incremental information, the main processing unit 10 stores the pattern usage record count as the second attribute information 62B in the storage unit 52.

The information output unit 74 outputs information to the main processing unit 10. For example, the information output unit 74 outputs, to the main processing unit 10, the incremental information for incrementing the pattern usage record count in the attribute information 62. For example, in a case where the packet does not correspond to the discard pattern 82A, in which the packet is discarded, or does not correspond to the proxy response pattern 82B, in which a proxy response is performed for the packet, the pattern usage record count may be output to the main processing unit 10 in response to a request from the main processing unit 10.

The information acquisition unit 75 acquires information from the main processing unit 10. For example, a request for deleting a pattern or executing the update processing for a new pattern is acquired from the main processing unit 10. For example, when the information acquisition unit 75 acquires the request for deleting the pattern from the main processing unit 10, the pattern update processing unit 71 executes pattern deletion processing. For example, when the information acquisition unit 75 acquires the request for executing the update processing for a new pattern from the main processing unit 10, the pattern update processing unit 71 executes the update processing for a new pattern.

The transmission unit 76 transmits information to the outside via the network 40. For example, the transmission unit 76 transmits a packet via the network 40.

The reception unit 77 receives information from the outside via the network 40. For example, the reception unit 77 receives a packet via the network 40.

### Operation According to First Exemplary Embodiment

Next, the operation of the information processing system 2 according to the first exemplary embodiment will be described.

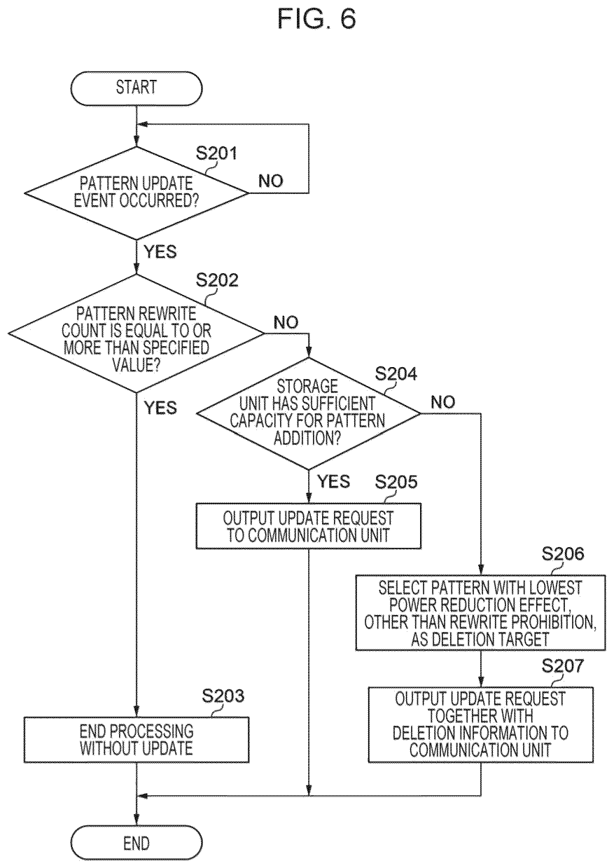

FIG. 6 is a flowchart illustrating a flow of the update determination processing executed by the main processing unit 10 of the information processing system 2 according to the first exemplary embodiment. In the main processing unit 10, the CPU 11 reads an information processing program for the update determination from the ROM 12 or the storage 14, loads the information processing program on the RAM 13, and executes the information processing program. Thus, the information processing is executed.

The CPU 11 determines whether an update event for the pattern 82 has occurred (step S201). The update event occurs when the pattern 82 needs to be updated. For example, the pattern 82 needs to be updated when the user changes the setting information of the attribute information 62 using the operation panel 20 or when the attribute information 62 is updated and the rank changes. For example, a case of occurrence of an update event for adding a new pattern to the storage unit 72 of the communication unit 30 will be described.

When the update event for the pattern 82 has not occurred (step S201: NO), the CPU 11 waits until the update event for the pattern 82 occurs.

When the update event for the pattern 82 occurs (step S201: YES), the CPU 11 determines whether the rewrite count for the pattern 82 is equal to or more than the specified value (step S202). The rewrite count for the pattern 82 is acquired from the communication unit 30. As described above, the specified value is a value obtained by subtracting a margin (for example, 20%) from the rewrite count related service life of the storage unit 72 of the communication unit 30. For example, the CPU 11 calculates the specified value from the rewrite count related service life of the storage unit 72 acquired from the communication unit 30, and determines whether the rewrite count for the pattern 82 is equal to or more than the specified value.

When the rewrite count for the pattern 82 is equal to or more than the specified value (step S202: YES), the CPU 11 ends the processing without updating the pattern 82 (step S203). In other words, since the rewrite count for the pattern 82 has reached the specified value, the pattern 82 is not updated. Thus, the processing executed, based on the information processing program, by the main processing unit 10 of the information processing system 2 ends.

When the rewrite count for the pattern 82 is less than the specified value (step S202: NO), the CPU 11 determines whether the storage unit 72 has a sufficient capacity for adding the pattern 82 (step S204). The capacity of the storage unit 72 is acquired from the communication unit 30.

When the storage unit 72 has a sufficient capacity for adding the pattern 82 (step S204: YES), the CPU 11 outputs an update request for the pattern 82 to the communication unit 30 (step S205). Upon receiving the update request for the pattern 82 from the main processing unit 10, the CPU 31 of the communication unit 30 executes the update processing for the pattern 82 (for example, update processing for adding a new pattern to the storage unit 72). Thus, the processing executed, based on the information processing program, by the main processing unit 10 of the information processing system 2 ends.

When the storage unit 72 does not have a sufficient capacity for adding the pattern 82 (step S204: NO), the CPU 11 selects the pattern 82 with the lowest power reduction effect other than the rewrite prohibition as the deletion target (step S206). For example, as illustrated in FIG. 4, based on the attribute information 62 (the first attribute information 62A to the fourth attribute information 62D), the CPU 11 selects, as the deletion target, the pattern 82 (for example, the pattern of the third example illustrated in FIG. 4) with the lowest power reduction effect other than the rewrite prohibition.

The CPU 11 outputs an update request together with deletion information to the communication unit 30 (step S207). Upon receiving the update request for the pattern 82 together with the deletion information from the main processing unit 10, the CPU 31 of the communication unit 30 deletes the deletion target pattern (for example, the pattern of the third example illustrated in FIG. 4) and then executes the update processing for the pattern 82 (for example, the update processing of adding a new pattern to the storage unit 72). Thus, the processing executed, based on the information processing program, by the main processing unit 10 of the information processing system 2 ends.

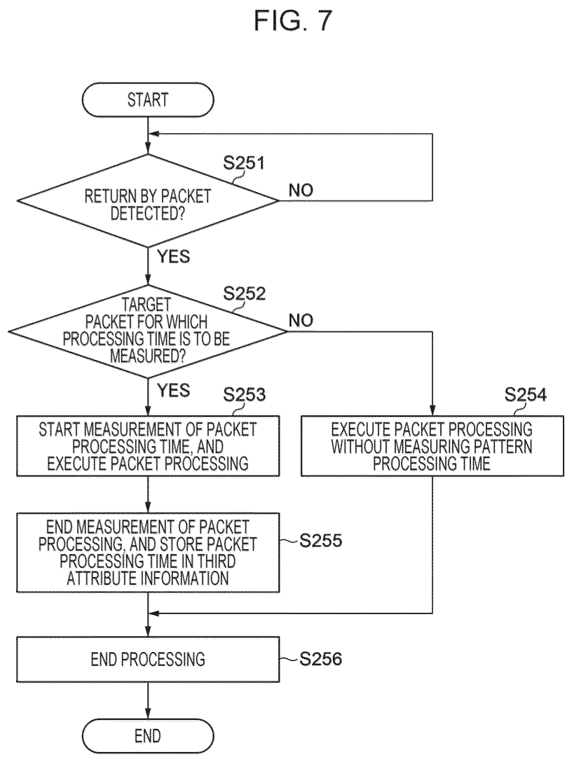

FIG. 7 is a flowchart illustrating a flow of processing of measuring a packet processing time executed by the main processing unit 10 of the information processing system 2 according to the first exemplary embodiment. In the main processing unit 10, the CPU 11 reads an information processing program for the measurement from the ROM 12 or the storage 14, loads the program on the RAM 13, and executes the program. Thus, the information processing is executed.

The CPU 11 determines whether a return by packet is detected (step S251). For example, this corresponds to a case where the packet does not correspond to the discard pattern 82A or the proxy response pattern 82B in the communication unit 30, and is processed by the main processing unit 10 activated (i.e., returned). When a signal for making the main processing unit 10 return is transmitted from the communication unit 30, the CPU 11 determines that the return by packet is detected.

When the return by packet is not detected (step S251: NO), the CPU 11 waits until the return by packet is detected.

When the return by packet is detected (step S251: YES), the CPU 11 determines whether the packet is a processing time measurement target packet (step S252). A packet not requiring the measurement is excluded through the determination on whether the packet is the processing time measurement target packet. For example, the processing time measurement target packet is a packet not involving a job (that is, a packet for which only the packet processing is executed). Since a packet not involving a job is a target of discarding (that is, removal by a filter) or a proxy response by the communication unit 30, the processing time is measured for such a packet. The non-target packet is a packet involving a job such as printing or scanning

When the packet is a target of the processing time measurement (step S252: YES), the CPU 11 starts measuring the packet processing time and executes the packet processing (step S253).

When the packet is not the target of the processing time measurement (step S252: NO), the CPU 11 executes the packet processing without measuring the packet processing time (step S254).

The CPU 11 ends the packet processing time measurement when the packet processing ends, and stores the packet processing time as the third attribute information 62C (step S255).

After the processing in step S254 or step S256, the CPU 11 ends the processing (step S256). Thus, the processing executed, based on the information processing program, by the main processing unit 10 of the information processing system 2 ends.

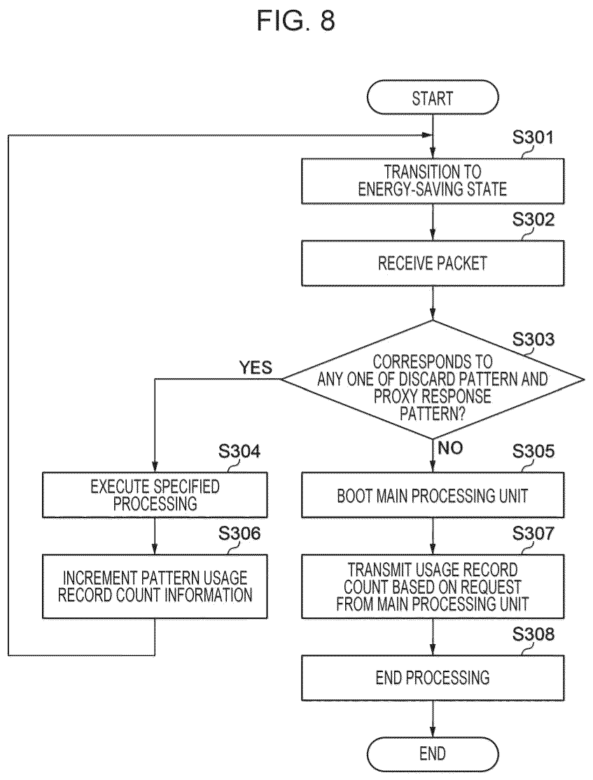

FIG. 8 is a flowchart illustrating a flow of processing of accumulating usage records executed by the communication unit 30 of the information processing system 2 according to the first exemplary embodiment. In the communication unit 30, the CPU 31 reads an information processing program for accumulating usage records from the ROM 32 or the storage 34, loads the program on the RAM 33, and executes the program. Thus, the information processing is executed.

The CPU 31 transitions to an energy-saving state (step S301). For example, when the main processing unit 10 transitions to the energy-saving state with the information processing system 2 not operating for a predetermined period of time, the communication unit 30 also transitions to the energy-saving state.

The CPU 31 receives a packet (step S302). In this example, the CPU 31 receives a packet from the outside via the network 40. The CPU 31 may make the communication unit 30 return from the energy-saving state to the normal state upon receiving a packet.

The CPU 31 determines whether the packet corresponds to any one of the discard pattern or the proxy response pattern (step S303). A packet corresponding to any one of the discard pattern and the proxy response pattern is a packet corresponding to one of the discard pattern 82A and the proxy response pattern 82B, and leads to “YES” in step S303 in this case. A packet corresponding to neither one of the discard pattern 82A and the proxy response pattern 82B is a packet not corresponding to the discard pattern 82A or the proxy response pattern 82B, and leads to “NO” in step S303.

When the packet corresponds to any one of the discard pattern or the proxy response pattern (step S303: YES), the CPU 31 executes specified processing (step S304). For example, when the packet corresponds to the discard pattern 82A, the CPU 31 executes processing of discarding the packet as the specified processing. For example, when the packet corresponds to the proxy response pattern 82B, the CPU 31 executes processing of performing a proxy response for the packet as the specified processing.

When the packet corresponds to none of the discard pattern and the proxy response pattern (step S303: NO), the CPU 31 boots the main processing unit 10 (step S305). For example, the CPU 31 boots the main processing unit 10 by outputting a return by packet signal to the main processing unit 10.

After the processing in step S304, the CPU 31 increments the information on the usage record count of the pattern 82 (the discard pattern 82A or the proxy response pattern 82B) (step S306). This incrementation is an operation of adding 1 to the numerical value. While the usage record count of the pattern 82 (the discard pattern 82A or the proxy response pattern 82B) is the second attribute information 62B, the processing in step S306 is executed without booting the main processing unit 10. For example, the CPU 31 temporarily stores the incremental information for the usage record count of the pattern 82 in the storage unit 72.

For example, the incremental information for the usage record count of the pattern 82 is transmitted to the main processing unit 10 when the main processing unit 10 is booted (returns). Thus, the CPU 11 of the main processing unit 10 stores the usage record count of the pattern 82 in the storage unit 52 as the second attribute information 62B based on the incremental information received from the communication unit 30.

The CPU 31 returns to the processing in step S301. Thus, the CPU 31 transitions to the energy-saving state again.

After the processing in step S305, the CPU 31 transmits the usage record count of the pattern 82 based on a request from the main processing unit 10 (step S307). The usage record count of the pattern 82 is stored as the second attribute information 62B in the storage unit 52 of the main processing unit 10.

The CPU 31 ends the processing (step S308). Thus, the processing based on the information processing program executed by the communication unit 30 of the information processing system 2 ends.

In general, there is a strong demand for reducing power consumption of a multifunction peripheral having functions such as those of printer, copier, fax machine, as well as e-mail transmission. In order to satisfy this demand, a filtering technique has been proposed for a multifunction peripheral of Comparative Example. According to such a technique, a discard pattern that is a condition for discarding a received packet is set in advance, and when a packet received during power saving control corresponds to the pattern, the packet is discarded by a communication unit without being processed by a main controller (such as a CPU). In addition, as a technique similar to the filter technique, there is a technique in which a proxy response pattern that is a condition for performing proxy response for a received packet is set in advance, and the proxy response is performed for a predetermined packet corresponding to the pattern.

However, in the multifunction peripheral of Comparative Example, since the type of the packet received frequently differs depending on the network environment, the power consumption may not be sufficiently reduced by simply setting the predetermined discard pattern or proxy response pattern.

The information processing system 2 according to the first exemplary embodiment includes the storage unit 72 that stores the plurality of patterns 82 for processing a packet received via the network 40, and the storage unit 52 that stores information of the patterns 82 and the attribute information 62 related to the power reduction effect in association with each other. In the information processing system 2, when a new pattern cannot be added to the storage unit 72 of the communication unit 30 due to a capacity shortage the storage unit 72, the CPU 11 causes execution of the update processing of deleting the pattern 82 with the lowest power reduction effect based on the attribute information 62 and then adding the new pattern to the storage unit 72.

Therefore, in the information processing system 2, when a new pattern is added to the storage unit 72, the pattern 82 with a high power reduction effect can be retained. Thus, the power consumption can be reduced by retaining the pattern 82 with a high power reduction effect in the information processing system 2.

In the information processing system 2, the CPU 11 acquires the rewrite count of the pattern 82, and when the rewrite count is equal to or more than the specified value, the CPU 11 does not cause the execution of the update processing of adding the new pattern to the storage unit 72. Therefore, in the information processing system 2, it is possible to suppress a decrease in the service life of the storage unit 72, compared with a case where the rewrite count of the pattern 82 is unlimited.

Furthermore, in the information processing system 2, the attribute information 62 includes the usage record count of the pattern 82 and the packet processing time. The CPU 11 selects, based on the usage record count and the processing time, the pattern 82 with the lowest power reduction effect to be deleted. For this reason, in the information processing system 2, the pattern 82 with a high power reduction effect is less likely to be deleted, compared with a case where the usage record count of the pattern and the packet processing time are not taken into consideration.

Additionally, in the information processing system 2, the attribute information 62 includes the rewritability information on the pattern 82, and the CPU 11 does not delete the pattern 82 of the storage unit 72 regardless of the power reduction effect when the pattern is unrewritable. Therefore, in the information processing system 2, the pattern 82 that is unrewritable can be prevented from being deleted.

In the information processing system 2, when the packet is a target of the processing time measurement, the CPU 11 measures the processing time of the packet and stores the processing time in the storage unit 52 of the main processing unit 10 as the attribute information 62. Therefore, in the information processing system 2, the pattern 82 with a higher power reduction effect is likely to be retained as compared with a case where the packet processing time is not taken into consideration.

In the information processing system 2, the packet as the processing time measurement target is a packet involving no job. For this reason, in the information processing system 2, the processing time is less likely to be measured for a packet the processing time for which varies depending on the job content.

The information processing system 2 further includes the communication unit 30 that performs packet communication via the network 40 and the CPU 31 provided in the communication unit 30. The pattern 82 includes the discard pattern 82A and the proxy response pattern 82B. When a packet received by the communication unit 30 corresponds to the discard pattern 82A or the proxy response pattern 82B, the CPU 31 processes the packet without activating the CPU 11 of the main processing unit 10. Therefore, in the information processing system 2, power consumption can be reduced, compared with a case where all the packets are processed by the CPU of the main processing unit.

Further, in the information processing system 2, after processing the packet, the CPU 31 stores the incremental information for incrementing the usage record count of the pattern 82 in the attribute information 62 in the storage unit 72, without activating the CPU 11 of the main processing unit 10. Therefore, the information processing system 2 can accumulate the attribute information 62 related to the power reduction effect.

In the information processing system 2, when the packet received by the communication unit 30 does not correspond to the discard pattern 82A or the proxy response pattern 82B, the CPU 31 outputs the usage record count of the pattern 82 to the CPU 11 in response to the request from the CPU 11 of the main processing unit 10. Thus, the CPU 11 causes the storage unit 52 to store the usage record count of the pattern 82 as the attribute information 62, whereby the attribute information 62 is accumulated. Therefore, in the information processing system 2, when the new pattern 82 is added to the storage unit 72, the pattern 82 with a high power reduction effect can be retained.

### Others

The processing system of the present disclosure is not limited to the information processing system 2 described in the first exemplary embodiment, and various changes can be made. For example, each of the components, such as the image forming unit 22, the scan unit 24, and the fax machine 26 provided in the information processing system 2 can be changed. Further, the storage unit 72 is provided in the communication unit 30, but the present disclosure is not limited thereto, and the storage unit 72 may be configured by a RAM or the like connected to the communication unit 30.

The processing in the information processing system 2 described above can also be implemented by a dedicated hardware circuit. In this case, the processing may be executed by a plurality of units of hardware.

Further, the program for operating the information processing system 2 may be provided by a computer-readable recording medium such as a universal serial bus (USB) memory, a flexible disk, or a compact disc read only memory (CD-ROM), or may be provided online via a network such as the Internet. In this case, the program recorded in the computer-readable recording medium is generally transferred to and stored in a memory, a storage, or the like. In addition, the program may be provided as, for example, independent application software, or may be incorporated into software of each device as one function of the information processing system 2.

While a specific exemplary embodiment of the present disclosure has been described in detail, the present disclosure is not limited to such an exemplary embodiment, and it is apparent to those skilled in the art that various other exemplary embodiments are possible within the scope of the present disclosure.

### APPENDIX

(((1)))

A processing system comprising:
a first storage unit configured to store part of a plurality of processing procedures for processing a packet received via a network;
a second storage unit configured to store information on the processing procedures and attribute information related to a power reduction effect in association with each other; and
a first processor configured to execute, when a new processing procedure is not able to be added to the first storage unit due to a capacity shortage of the first storage unit, update processing of deleting one of the processing procedures the power reduction effect provided by which is lowest based on the attribute information and then adding the new processing procedure to the first storage unit.
(((2)))

The processing system according to (((1))), wherein the first processor is configured to acquire a rewrite count of the processing procedure, and when the rewrite count is equal to or more than a specified value, the first processor is configured not to execute the update processing of adding the new processing procedure to the first storage unit.
(((3)))

The processing system according to (((1))) or (((2))), wherein
the attribute information includes a usage record count of the processing procedure and a processing time for processing the packet, and
the first processor is configured to select the processing procedure the power reduction effect provided by which is lowest to be deleted based on the usage record count and the processing time.
(((4)))

The processing system according to any one of (((1))) to (((3))), wherein
the attribute information includes rewritability information on the processing procedure, and
the first processor is configured not to delete the processing procedure in the first storage unit regardless of the power reduction effect, when the processing procedure is unrewritable.
(((5)))

The processing system according to any one of (((1))) to (((4))), wherein, when the packet is a target of measurement of the processing time, the first processor is configured to measure the processing time for the packet and store the processing time as the attribute information in the second storage unit.
(((6)))

The processing system according to (((5))), wherein the packet that is the target of the measurement of the processing time is a packet involving no job.
(((7)))

The processing system according to any one of (((1))) to (((6))), further comprising:
a communication unit configured to perform communication for the packet via the network; and
a second processor provided in the communication unit, wherein
the processing procedures include a processing procedure of performing discarding or proxy response in the communication unit, and
the second processor is configured to process the packet without activating the first processor when the packet received by the communication unit corresponds to the processing procedure of performing discarding or the proxy response.
(((8)))

The processing system according to (((7))), wherein, after processing the packet, the second processor is configured to store, in the first storage unit, incremental information for incrementing a usage record count of the processing procedure in the attribute information, without activating the first processor.
(((9)))

The processing system according to (((7))), wherein the second processor is configured to output a usage record count of the processing procedure to the first processor in response to a request from the first processor when the packet does not correspond to the processing procedure for performing the discarding or the proxy response.
(((10)))

A processing method comprising executing by a computer, when a new processing procedure is not able to be added to a first storage unit configured to store part of a plurality of processing procedures for processing a packet received via a network due to a capacity shortage of the first storage unit, update processing of deleting one of the processing procedures power reduction effect provided by which is lowest, based on attribute information stored in a second storage unit configured to store information on the processing procedure and the attribute information related to the power reduction effect in association with each other, and then adding the new processing procedure to the first storage unit.

What is claimed is:

1. A processing system comprising:
a first storage unit configured to store part of a plurality of processing procedures for processing a packet received via a network;
a second storage unit configured to store information on the processing procedures and attribute information related to a power reduction effect in association with each other; and
a first processor configured to execute, when a new processing procedure is not able to be added to the first storage unit due to a capacity shortage of the first storage unit, update processing of deleting one of the processing procedures the power reduction effect provided by which is lowest based on the attribute information and then adding the new processing procedure to the first storage unit.

2. The processing system according to claim 1, wherein the first processor is configured to acquire a rewrite count of the processing procedure, and when the rewrite count is equal to or more than a specified value, the first processor is configured not to execute the update processing of adding the new processing procedure to the first storage unit.

3. The processing system according to claim 1, wherein
the attribute information includes a usage record count of the processing procedure and a processing time for processing the packet, and
the first processor is configured to select the processing procedure the power reduction effect provided by which is lowest to be deleted based on the usage record count and the processing time.

4. The processing system according to claim 1, wherein
the attribute information includes rewritability information on the processing procedure, and
the first processor is configured not to delete the processing procedure in the first storage unit regardless of the power reduction effect, when the processing procedure is unrewritable.

5. The processing system according to claim 1, wherein, when the packet is a target of measurement of the processing time, the first processor is configured to measure the processing time for the packet and store the processing time as the attribute information in the second storage unit.

6. The processing system according to claim 5, wherein the packet that is the target of the measurement of the processing time is a packet involving no job.

7. The processing system according to claim 1, further comprising:
a communication unit configured to perform communication for the packet via the network; and
a second processor provided in the communication unit, wherein
the processing procedures include a processing procedure of performing discarding or proxy response in the communication unit, and
the second processor is configured to process the packet without activating the first processor when the packet received by the communication unit corresponds to the processing procedure of performing discarding or the proxy response.

8. The processing system according to claim 7, wherein, after processing the packet, the second processor is configured to store, in the first storage unit, incremental information for incrementing a usage record count of the processing procedure in the attribute information, without activating the first processor.

9. The processing system according to claim 7, wherein the second processor is configured to output a usage record count of the processing procedure to the first processor in response to a request from the first processor when the packet does not correspond to the processing procedure for performing the discarding or the proxy response.

10. A processing method comprising:
executing by a computer, when a new processing procedure is not able to be added to a first storage unit configured to store part of a plurality of processing procedures for processing a packet received via a network due to a capacity shortage of the first storage unit, update processing of deleting one of the processing procedures power reduction effect provided by which is lowest, based on attribute information stored in a second storage unit configured to store information on the processing procedure and the attribute information related to the power reduction effect in association with each other, and then adding the new processing procedure to the first storage unit.
